(19) United States
(12) Patent Application Publication
(10) Pub. No.: US 2026/0046775 A1
(43) Pub. Date: Feb. 12, 2026

(54) SUPPORTING UL-WUS CONFIGURATION

(71) Applicant: QUALCOMM Incorporated, San Diego, CA (US)

(72) Inventors: Jianghong LUO, Skillman, NJ (US); Navid ABEDINI, Basking Ridge, NJ (US); Hung Dinh LY, San Diego, CA (US); Qing LI, Princeton Junction, NJ (US); Jae Ho RYU, San Diego, CA (US)

(21) Appl. No.: 19/288,910

(22) Filed: Aug. 1, 2025

Related U.S. Application Data
(60) Provisional application No. 63/680,568, filed on Aug. 7, 2024.

(51) Int. Cl. H04W 52/02; H04W 74/0833

(52) U.S. Cl. CPC H04W 52/0235; H04W 74/0833

(57) ABSTRACT

Apparatus, methods, and computer program products for wireless communication are provided. An example method may include receiving, from a network energy saving (NES) cell, an uplink wake-up signal (UL-WUS) configuration for a set of NES cells. The example method may include acquiring MIB/SIB of a non-NES cell for validity check of UL-WUS configuration for a NES cell and receiving an updated UL-WUS configuration. In example aspects, a UE may follow priority rules for cell reselection based on NES type of source and/or target cells.

### CROSS REFERENCE TO RELATED APPLICATION(S)

This application claims the benefit of and priority to U.S. Provisional Application Ser. No. 63/680,568, entitled “SUPPORTING UL-WUS CONFIGURATION” and filed on Aug. 7, 2024, which is expressly incorporated by reference herein in its entirety.

### TECHNICAL FIELD

The present disclosure relates generally to communication systems, and more particularly, to wireless communication systems with uplink wake-up signal (UL-WUS).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor is configured to (e.g., cause the UE to) receive, from a network energy saving (NES) cell, an uplink wake-up signal (UL-WUS) configuration for a set of NES cells. Based at least in part on information stored in the at least one memory, the at least one processor is configured to transmit, to a first NES cell in the set of NES cells, a physical random access channel (PRACH) request based on the UL-WUS configuration. Based at least in part on information stored in the at least one memory, the at least one processor is configured to receive, from the first NES cell, a system information block (SIB) in response to the PRACH request.

In another aspect of the disclosure, a method, a computer-readable medium, and an apparatus at a UE are provided. The apparatus may include at least one memory and at least one processor coupled to the at least one memory. Based at least in part on information stored in the at least one memory, the at least one processor is configured to obtain a master information block (MIB) and a system information block (SIB) associated with a non-network energy saving (NES) cell, where the non-NES cell is associated with an NES cell. Based at least in part on information stored in the at least one memory, the at least one processor is configured to determine a validity of an uplink wake-up signal (UL-WUS) configuration for the NES cell based on the SIB associated with the non-NES cell, where the UL-WUS configuration for the NES cell is stored in the at least one memory. Based at least in part on information stored in the at least one memory, the at least one processor is configured to transmit, to the NES cell after determination of the validity of the UL-WUS configuration for the NES cell, a physical random access channel (PRACH) request based on the UL-WUS configuration. Based at least in part on information stored in the at least one memory, the at least one processor is configured to receive, from the NES cell, a response to the PRACH request.

In another aspect of the disclosure, a method, a computer-readable medium, and an apparatus at a UE are provided. The apparatus may include at least one memory and at least one processor coupled to the at least one memory. Based at least in part on information stored in the at least one memory, the at least one processor is configured to (e.g., cause the UE to) obtain information associated with a set of cells. Based at least in part on information stored in the at least one memory, the at least one processor is configured to select a target cell of the set of cells for cell reselection, where a subset of network energy saving (NES) cells in the set of cells is associated with a lower priority for the selection of the target cell based on a first type of a source cell of the UE or a second type of the target cell. Based at least in part on information stored in the at least one memory, the at least one processor is configured to transmit a physical random access channel (PRACH) request to the target cell.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example communications between a UE, a network energy saving (NES) cell, and a non-NES cell (cell A).

FIG. 5 is a diagram illustrating example communications between a UE, an NES cell, and a non-NES cell.

FIG. 6 is a diagram illustrating example environment with UEs, NES cells, and non-NES cells.

FIG. 7 is a diagram illustrating example communications between a UE, a first NES cell, or a second NES cell.

FIG. 8 is a diagram illustrating example communications between a UE, an NES cell, and a non-NES cell.

FIG. 9 is a diagram illustrating example communications between a UE, a source cell, and a target cell.

FIG. 10 is a flowchart of a method of wireless communication.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

FIG. 14 is a flowchart of a method of wireless communication.

FIG. 15 is a diagram illustrating an example of a hardware implementation for an example network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

For uplink wake-up signal (UL-WUS) configuration, in some wireless communication systems, a non-network energy saving (NES) cell indicates UL-WUS configuration for one or more other cells (that are NES cells). In some situations, a user equipment (UE) may miss system information (SI) change indication from non-NES cell while camping in the source NES cell. During cell reselection, the UE may not be aware that its stored UL-WUS configuration is obsolete. If UE sends physical random access channel (PRACH) request based on an obsolete UL-WUS configuration, there will be many PRACH retransmit until failure of on-demand system information block 1 (OD-SIB1). A UE may not tune to non-NES cell to check validity of the non-NES cell's SIB X nor to acquire the updated SIB X during cell reselection between two NES cells. A UE's behavior may be undefined during selection/reselection to an NES cell without a stored UL-WUS configuration for this NES cell (e.g., no previous acquisition of a non-NES cell for the NES cell). Aspects provided herein provide more efficient cell selection/reselection mechanisms in connection with NES cells that have a lower failure rate. In a first example, an NES cell may transmit a UL-WUS configuration for one or more NES cells. In a second example, additional rules may be defined for cell selection/reselection procedure in connection with NES cells so that cell selection/reselection may be more efficient. In a third example, UE behavior for acquiring master system information (MIB)/system information block (SIB) 1 of an associated non-NES cell before transmitting PRACH request to an NES cell. In a fourth example, the UE may store and manage associated non-NES cell for a NES cell in a particular fashion that enable more efficient cell selection/reselection.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

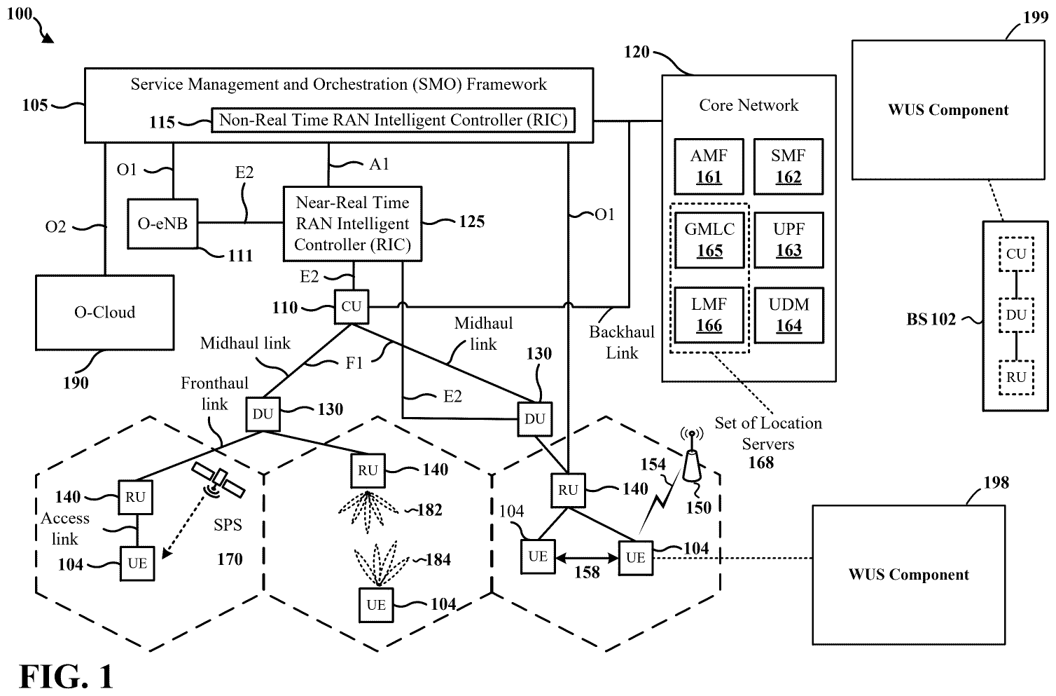

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a WUS component 198. In some aspects, the WUS component 198 may be configured to receive, from a network energy saving (NES) cell, an uplink wake-up signal (UL-WUS) configuration for a set of NES cells. In some aspects, the WUS component 198 may be configured to transmit, to a first NES cell in the set of NES cells, a physical random access channel (PRACH) request based on the UL-WUS configuration. In some aspects, the WUS component 198 may be configured to receive, from the first NES cell, a system information block (SIB) in response to the PRACH request.

In some aspects, the WUS component 198 may be configured to obtain a master information block (MIB) and a system information block (SIB) associated with a non-network energy saving (NES) cell, where the non-NES cell is associated with an NES cell. In some aspects, the WUS component 198 may be configured to determine a validity of an uplink wake-up signal (UL-WUS) configuration for the NES cell based on the SIB associated with the non-NES cell, where the UL-WUS configuration for the NES cell is stored in the at least one memory. In some aspects, the WUS component 198 may be configured to transmit, to the NES cell after determination of the validity of the UL-WUS configuration for the NES cell, a physical random access channel (PRACH) request based on the UL-WUS configuration. In some aspects, the WUS component 198 may be configured to receive, from the NES cell, a response to the PRACH request.

In some aspects, the WUS component 198 may be configured to obtain information associated with a set of cells. In some aspects, the WUS component 198 may be configured to select a target cell of the set of cells for cell reselection, where a subset of network energy saving (NES) cells in the set of cells is associated with a lower priority for the selection of the target cell based on a first type of a source cell of the UE or a second type of the target cell. In some aspects, the WUS component 198 may be configured to transmit a physical random access channel (PRACH) request to the target cell.

In certain aspects, the base station 102 may include a WUS component 199. In some aspects, the WUS component 199 may be configured to transmit, for a UE, an UL-WUS configuration for a set of NES cells. In some aspects, the WUS component 199 may be further configured to receive, from the UE, a PRACH request based on the UL-WUS configuration. In some aspects, the WUS component 199 may be further configured to transmit, for the UE, a SIB in response to the PRACH request.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

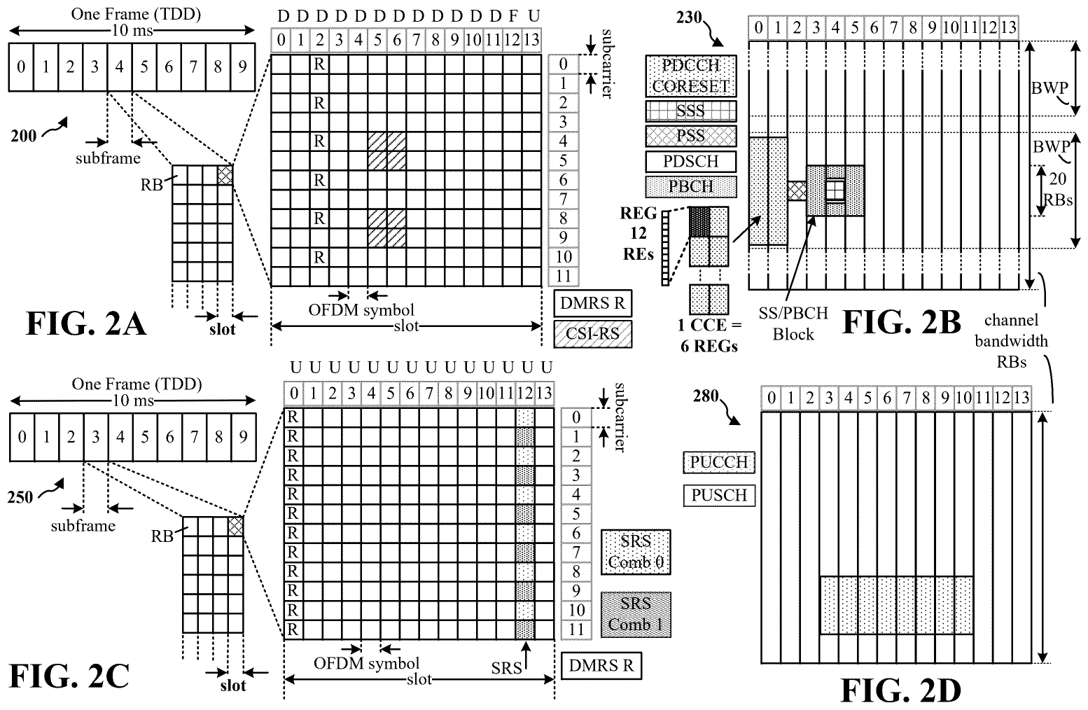

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ} *15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

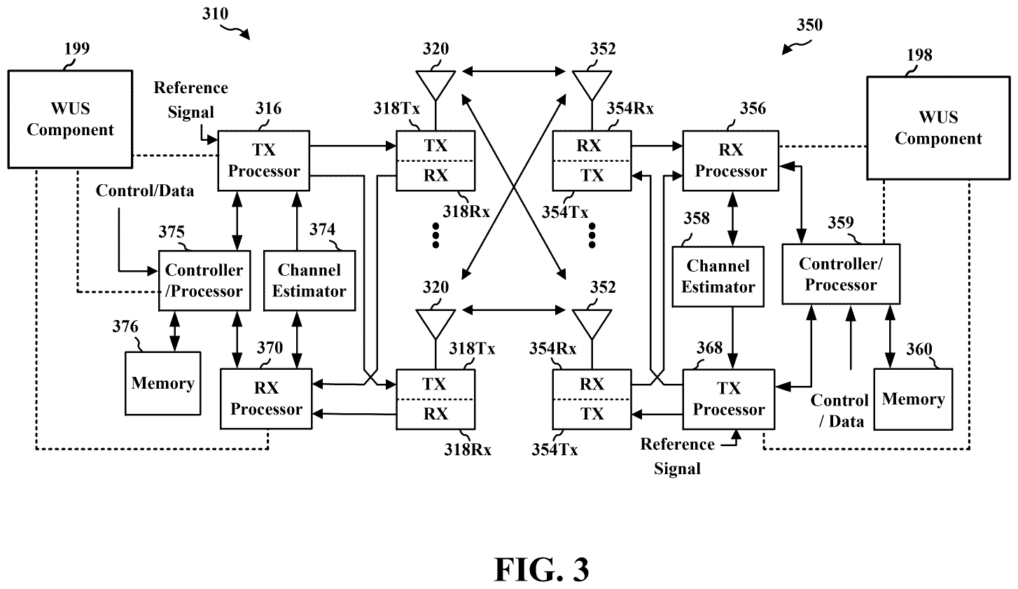

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with WUS component 198 of FIG. 1.

At least one of the TX processor 316, the RX processor 370, and the controller/processor 375 may be configured to perform aspects in connection with WUS component 199 of FIG. 1.

The term “camp” may refer to a state where a UE has successfully completed the process of selecting and registering with a particular cell in the network. When the UE is camped on a cell, the UE may receive and transmit data based on that cell. The cell that the UE is currently camped on may be referred to as “source cell” and a cell that the UE would camp on after cell reselection may be referred to as “target cell.” MIB may provide information used to acquire other system information (e.g., SIB) and may include system frame number, subcarrier spacing, and cell bandwidth. There may be various types of SIB. SIB1 may be SIB that includes information for initial access to the network, such as cell access-related parameters, public land mobile network (PLMN) identity, and scheduling information for other SIBs. SIB2 may provide radio resource configuration information common for all UEs in the cell and may include parameters for physical layer configuration and random access procedures. SIB3 may include cell re-selection information used by UEs in idle mode. Example parameters included in SIB3 may include parameters related to intra-frequency, inter-frequency, and inter-radio access technology cell re-selection. Other SIBs, such as SIB4 and SIB5, may include additional information that can be used for various purposes like inter-frequency measurements, inter-RAT re-selection, and specific service information. As used herein, the term “SIB X” may refer to a SIB that is not SIB1.

As used herein, the term “non-network energy saving (NES) cell” or “cell A” may refer to a cell that is periodically transmitting its own SIB1. To facilitate energy saving at network nodes, some cells/network nodes may not be periodically transmitting its own SIB1, but rather transmit SIB1 in response to a “uplink wake-up signal (UL-WUS)” from a UE. Such SIB1 in response to a UL-WUS may be referred to as on-demand (OD) SIB. As used herein, the term “network energy saving (NES) cell” may refer to a cell that transmits SIB1 in response to a UL-WUS and does not periodically transmit its own SIB1. As used herein, the term “UL-WUS” may refer to a transmission that triggers an NES cell to transmit SIB1. As used herein, the term “UL-WUS configuration” may refer to a configuration for transmission of UL-WUS, which may include identifier (ID), such as physical cell ID and frequency of at least one cell associated with the UL-WUS configuration (e.g., at least one cell where the UL-WUS configuration may be applicable for). The UL-WUS configuration may further include configurations related to the transmission of the UL-WUS, such as SIB1-request configuration that may include SS/PBCH block power, RACH occasion for SIB1, SIB1 request period, SIB1 request resource, or the like. The UL-WUS configuration may also include frequency information for uplink such as frequency band list, offset to carrier, frequency shift, or the like. The UL-WUS configuration may also include configurations related to reception of SIB1, such as a PDCCH configuration associated with the SIB1 that would be transmitted by the NES cell upon receiving the UL-WUS. The UL-WUS configuration may also include SSB position in burst, or other SSB related configurations. A UL-WUS may be alternatively referred to as “PRACH to request SIB1” or similar terminology.

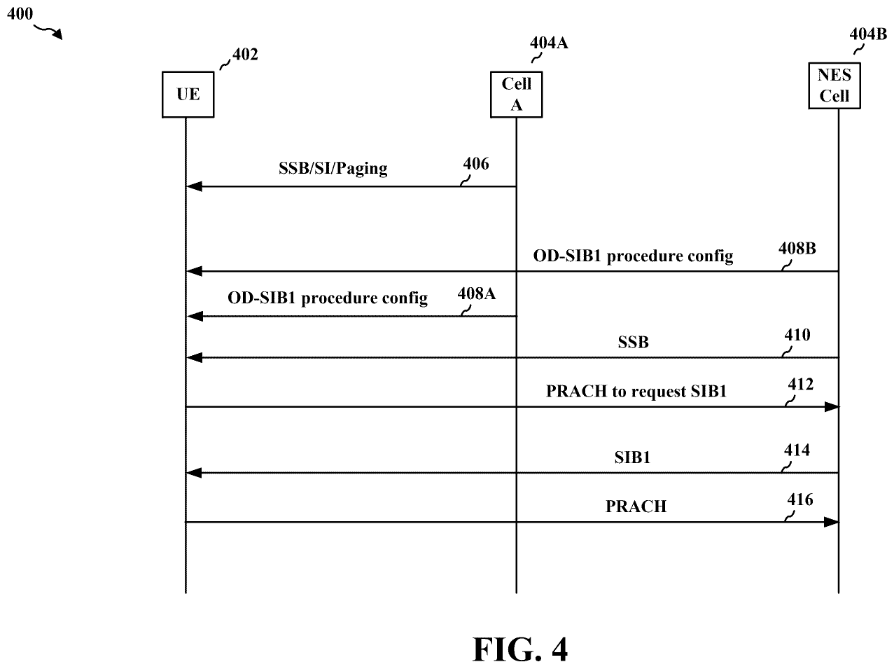

FIG. 4 is a diagram 400 illustrating example communications between a UE, a network energy saving (NES) cell, and a non-NES cell (cell A). As illustrated in FIG. 4, for cell reselection, the UE 402 may receive SSB, system information (SI), or paging, which may be referred to as SSB/SI/paging 406 from a non-NES cell 404A. After receiving the SSB/SI/paging 406 from the non-NES cell 404A, the UE 402 may receive on-demand (OD)-SIB procedure configuration, from the non-NES cell 404A or an NES cell 404B. In some aspects, the UE 402 may receive OD-SIB procedure configuration 408A from the non-NES cell 404A. In some aspects, the UE 402 may receive OD-SIB procedure configuration 408B from the NES cell 404B. After receiving the OD-SIB procedure configuration 408B or the OD-SIB procedure configuration 408B, the UE 402 may receive SSB 410 from the NES cell 404B. Upon receiving the SSB 410 from the NES cell 404B, the UE 402 may transmit a PRACH request 412 to request SIB1 from the NES cell 404B as part of a RACH procedure. After receiving the PRACH request 412 to request SIB1 from the NES cell 404B, in response, the NES cell 404B may transmit a SIB1 414 to the UE 402, which may then respond with another PRACH message 416 to continue the RACH procedure.

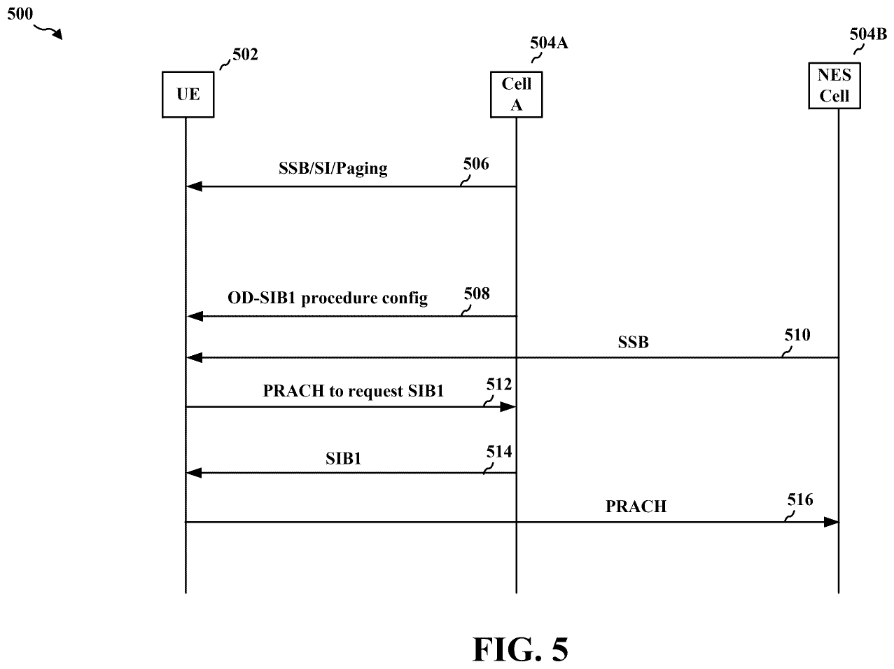

FIG. 5 is a diagram 500 illustrating example communications between a UE 502, an NES cell 504B, and a non-NES cell 504A. As illustrated in FIG. 5, for cell reselection, the UE 502 may SSB/SI/paging 506 from a non-NES cell 404A. After receiving the SSB/SI/paging 506 from the non-NES cell 504A, the UE 502 may receive OD-SIB procedure configuration 508 from the non-NES cell 504A. After receiving the OD-SIB procedure configuration 508, the UE 502 may receive SSB 510 from the NES cell 504B. Upon receiving the SSB 510 from the NES cell 404B, the UE 502 may transmit a PRACH request 512 to request SIB1 from the non-NES cell 504A as part of a RACH procedure. After receiving the PRACH request 512 to request SIB1, in response, the non-NES cell 504A may transmit a SIB1 514 to the UE 502, which may then transmit another PRACH message 516 to the NES cell 504B to continue the RACH procedure. In some aspects, an UL-WUS configuration may be for OD-SIB1 and may be included in OD-SIB1 procedure configuration. In some aspects, UL-WUS configuration may be separate from OD-SIB1 procedure configuration.

In some aspects, the PRACH request 412 to request SIB1 and the PRACH request 512 to request SIB1 may be UL-WUS. In some aspects, the source of the UL-WUS configuration may be OD-SIB1 procedure configuration 408A, OD-SIB1 procedure configuration 408B, or OD-SIB1 procedure configuration 508. In some wireless communication systems, an UL-WUS configuration may be carried by a non-NES cell but not an NES cell.

Validity check may be performed on SIB X (SIBs other than SIB1). For example, the validity check may be a value tag (represented by information element (IE) valueTag), an area scope (represented by IE areaScope), and a system information area identifier (ID) (represented by IE SystemInformationAreaID) that may be carried by periodic SIB1 associated with the SIB X. The system information area ID is the ID of the cell used by all SIBs. The value tag and area scope may be per SIB X. If the IE areaScope is present, the SIB X may be valid if value tag and associated public land mobile network (PLMN), and system information ID acquired from the periodic SIB1 are equal to stored values. If the IE areaScope is not present, the SIB X may be valid if value tag and associated PLMN and cell identity acquired from the periodic SIB1 are equal to stored values. Area scope may be geographical or logical area over which the information contained in the SIB is relevant or applicable, such as a cell scope (e.g., whether the SIB is cell-specific), area scope (e.g., specific to a particular geographic location or area). As one example, if the IE arcaScope is present, the SIB may be geographic area specific. If the IE areaScope is not present, the SIB may be cell-specific. Value tag may be an IE that represents whether the SIB has changed. In some aspects, an UL-WUS configuration may be applicable to a single cell. In some aspects, an UL-WUS configuration may be applicable to multiple cells.

In some wireless communication systems, UL-WUS configuration for a set of NES cells is carried by cell A's SIB X (not SIB1). In some aspects, UL-WUS configuration may include multiple sub-configs, each sub-configuration per NES cell, or each sub-configuration per a subset of NES cells. In some aspects, validation of SIB X may be based on (valueTag, areaScope, systemInformationAreaID) indicated by cell A's periodic SIB1. In some aspects, whether the indicated valueTag is equivalent to a stored value tag associated with the PLMN, cell identity, or system information area ID may be checked. As used herein, the term “a non-NES cell (or cell A) associated with an NES cell” may refer to non-NES cell/cell A that carries UL-WUS configuration for the NES cell. An NES cell may have one or more associated cell A's. An NES cell may be fully or partially or not covered by an associated cell A. For example, if the SIB X is area-specific (the IE areaScope is present), for cell A1 and cell A2 with the same IE systemInformationAreaID, a SIB X associated with the cell A1 and the cell A2. As a second example,

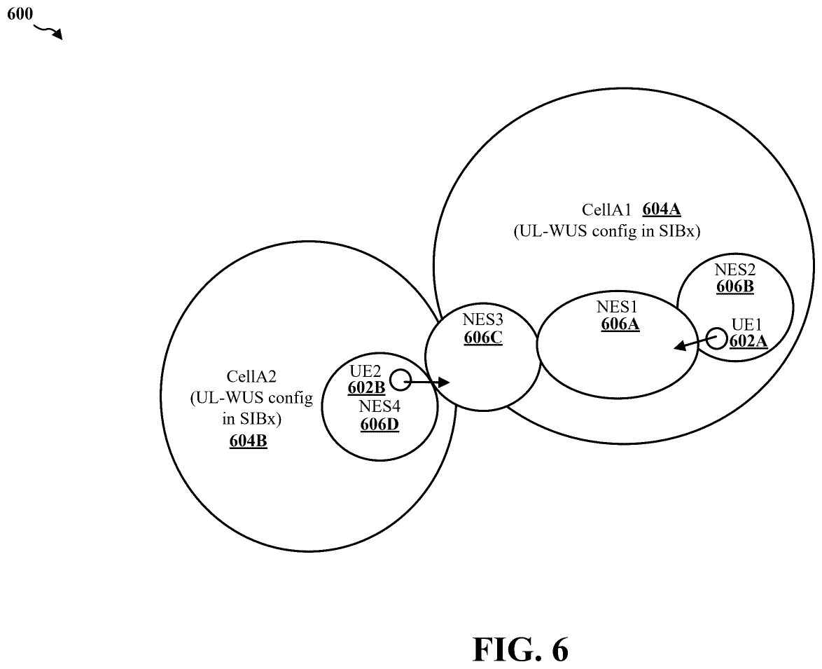

FIG. 6 is a diagram 600 illustrating example environment with UEs, NES cells, and non-NES cells. For the first example, cell A1 604A and cell A2 604B may be associated with a same SIB X and a same UL-WUS configuration. The NES cells, including NES cell 1 606A, NES cell 2 606B, NES cell 3 606C, and NES cell 4 606D, may be associated with the same UL-WUS configuration and each of the NES cell 1 606A, the NES cell 2 606B, the NES cell 3 606C, and the NES cell 4 606D, may have two associated cell As, the cell A1 604A and the cell A2 604B. A UE1 602A and a UE2 602B may receive the same UL-WUS configuration.

As a second example, SIB X may be cell-specific. In some aspects, each NES cell has one associated cell A. For example, cell A1 604A may carry UL-WUS configuration for the NES cell 1 606A, the NES cell 2 606B, and the NES cell 3 606C. Cell A2 604B may carry UL-WUS configuration for the NES cell 4 606D. In some aspects, a boundary NES cell (e.g., NES cell 3 606C) has two associated cell As. For example, cell A1 604A may carry UL-WUS configuration for the NES cell 1 606A, the NES cell 2 606B, and the NES cell 3 606C. Cell A2 604B may carry UL-WUS configuration for the NES cell 3 606C and the NES cell 4 606D.

For UL-WUS configuration, in some wireless communication systems, a non-NES cell indicates UL-WUS configuration for one or more other cells (that are NES cells). In some situations, a UE may miss SI change indication from non-NES cell while camping in the source NES cell. During cell reselection, the UE may not be aware that its stored UL-WUS configuration is obsolete. If UE sends PRACH request based on an obsolete UL-WUS configuration, there will be many PRACH retransmit until failure of OD-SIB1. A UE may not tune to non-NES cell to check validity of the non-NES cell's SIB X nor to acquire the updated SIB X during cell reselection between two NES cells. A UE's behavior may be undefined during selection/reselection to an NES cell without a stored UL-WUS configuration for this NES cell (e.g., no previous acquisition of a non-NES cell for the NES cell). Aspects provided herein provide more efficient cell selection/reselection mechanisms in connection with NES cells that have a lower failure rate. In a first example, an NES cell may transmit a UL-WUS configuration for one or more NES cells. In a second example, additional rules may be defined for cell selection/reselection procedure in connection with NES cells so that cell selection/reselection may be more efficient. In a third example, UE behavior for acquiring MIB/SIB1 of an associated non-NES cell before transmitting PRACH request to an NES cell. In a fourth example, the UE may store and manage associated non-NES cell for a NES cell in a particular fashion that enable more efficient cell selection/reselection.

In some aspects, a NES cell may transmit a UL-WUS configuration for one or more NES cells to avoid/minimize the use of validation and acquisition of UL-WUS configuration during cell reselection to a NES cell. While UE is camping on a cell carrying the UL-WUS configuration, the UE may have a valid stored UL-WUS configuration for the NES cell(s) associated with the camped NES cell (e.g., via the framework of SI change indication). The message that carries UL-WUS configuration can be a SIB message, an RRC release message, or the like. The UL-WUS configuration transmitted by an NES cell may include configuration for one or more of following NES cells: the NES cell transmitting the UL-WUS configuration, one or more NES cells that are neighbor cells of the NES cell transmitting the UL-WUS configuration, or one or more NES cells that are not neighbor cells of the NES cell transmitting the UL-WUS configuration. For example, configuring a UE with UL-WUS configurations of neighbor cells of the NES cell transmitting the UL-WUS configuration may avoid/minimize the use of validation and acquisition of UL-WUS configuration (for a UE) during the UE's cell reselection to an NES cell, if the cell reselection is within the neighbor cells of the NES cell transmitting the UL-WUS configuration. Further expanding the scope to include one or more NES cells that are not neighbor cells of the NES cell may further minimize the use of validation and acquisition of UL-WUS configuration (for a UE) during the UE's cell reselection to an NES cell, even if the cell reselection is not within the neighbor cells of the NES cell transmitting the UL-WUS configuration (e.g., but may introduce further signaling overhead as a trade-off). In some aspects, an NES cell may indicate its own UL-WUS configuration (referred to as configuration X) in a first message and provide indication about the UL-WUS configuration of one or multiple of neighboring NES cells in a second message. For example, the first message may be SIB1 and the second message may be SIB2/3/4 or SIB X. In some aspects, the first message and the second message may be equivalent to each other and may be SIB1 or SIB X. In some aspects, the indication can be in the form of any combination of: (1) whether the same UL-WUS configuration X can be used for neighboring NES cells, (e.g., one bit of information), (2) a first list of frequencies to which UL-WUS configuration X is applicable, (3) a second list of (cell IDs, and carrier frequencies) to which UL-WUS configuration X is applicable, (4) a delta configuration (e.g., configuring difference) compared to configuration X for the cells in the first or second list above, or (5) index to a table with a list of values for UL-WUS configuration parameters.

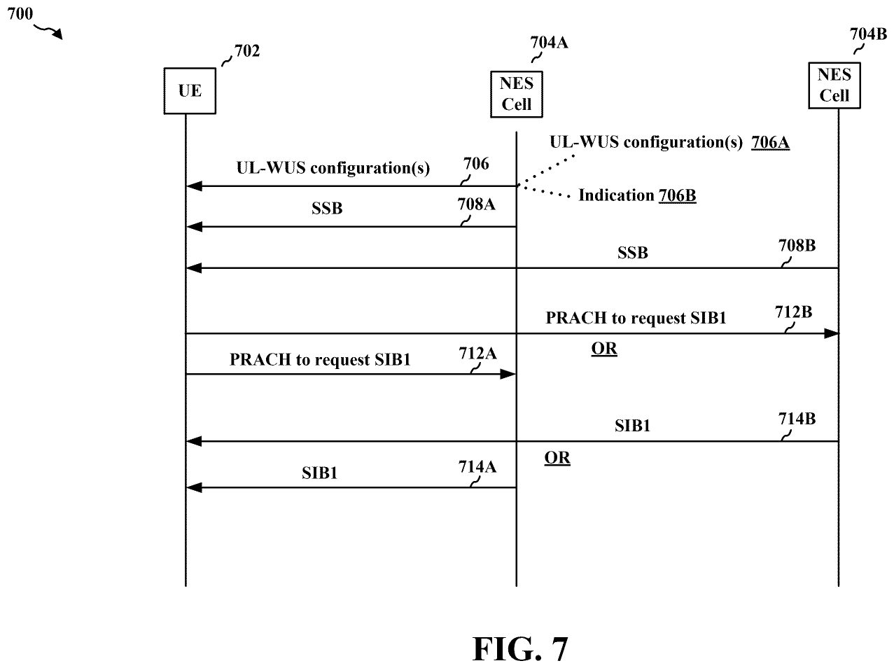

FIG. 7 is a diagram 700 illustrating example communications between a UE 702, a first NES cell 704A, or a second NES cell 704B. As illustrated in FIG. 7, the UE 702 (e.g., may be camped on the first NES cell 704A) may receive UL-WUS configuration 706 from the first NES cell 704A. The UL-WUS configuration 706 may include UL-WUS configuration 706 for one or more of following NES cells: the NES cell (the first NES cell 704A) transmitting the UL-WUS configuration, one or more NES cells (e.g., second NES cell 704B) that are neighbor cells of the NES cell transmitting the UL-WUS configuration, or one or more NES cells that are not neighbor cells of the NES cell transmitting the UL-WUS configuration. For example, configuring a UE with UL-WUS configurations of neighbor cells of the NES cell transmitting the UL-WUS configuration may avoid/minimize the use of validation and acquisition of UL-WUS configuration (for a UE) during the UE's cell reselection to an NES cell, if the cell reselection is within the neighbor cells of the NES cell transmitting the UL-WUS configuration. Further expanding the scope to include one or more NES cells that are not neighbor cells of the NES cell may further minimize the use of validation and acquisition of UL-WUS configuration (for a UE) during the UE's cell reselection to an NES cell, even if the cell reselection is not within the neighbor cells of the NES cell transmitting the UL-WUS configuration (e.g., but may introduce further signaling overhead as a trade-off). In some aspects, the UL-WUS configuration 706 may be transmitted in a first message 706A that includes UL-WUS configuration for the first NES cell 704A, and indication 706B in a second message. In some aspects, the indication and the UL-WUS configuration for the first NES cell 704A may be included in a single message. Including both in a single message may introduce less signaling overhead by not having two separate messages, but having the indication and the UL-WUS configuration as two separate messages may allow adjustments in view of particular situations at the UE and may make each individual message to be smaller. For example, the first NES cell 704A may transmit the indication 706B at a later time than the UL-WUS configuration for the first NES cell 704A. In some aspects, the indication may include or may be in the form of any combination of: (1) whether the same UL-WUS configuration X can be used for neighboring NES cells, (e.g., one bit of information), (2) a first list of frequencies to which UL-WUS configuration X is applicable, (3) a second list of (cell IDs, and carrier frequencies) to which UL-WUS configuration X is applicable, (4) a delta configuration (e.g., configuring difference) compared to configuration X for the cells in the first or second list above, or (5) index to a table with a list of values for UL-WUS configuration parameters. By indicating whether the same UL-WUS configuration X can be used for neighboring NES cells, the signaling overhead may be reduced if the same UL-WUS configuration X can be used for neighboring NES cells (e.g., one bit of information to indicate re-use of the same UL-WUS configuration X). The first list of frequencies to which UL-WUS configuration X is applicable and the second list of (cell IDs, and carrier frequencies) to which UL-WUS configuration X is applicable may be used by the UE to identify cells that may use the same UL-WUS configuration X. Such a mechanism may allow a flexible configuration where the UE may re-use the same UL-WUS configuration X for the right cells. The delta configuration (e.g., configuring difference) compared to configuration X for the cells in the first or second list above or the index to a table with a list of values for UL-WUS configuration parameters may allow for reduction in the signaling overhead in circumstances where some cells use a different UL-WUS configuration than the UL-WUS configuration X. In some aspects, the UL-WUS configuration 706 may be transmitted in one message that includes UL-WUS configurations for the first NES cell 704A and one or more neighbor cells, including the second NES cell 704B. In some aspects, the UL-WUS configuration 706 may be transmitted in a SIB that is different from SIB1, or different from SIBs 2-5.

In some aspects, after receiving the UL-WUS configuration 706, the UE 702 may receive SSB 708A from the first NES cell 704A or SSB 708B from the second NES cell 704B. In some aspects, during cell selection or reselection, the UE 702 may transmit a PRACH to request SIB1 712A to the first NES cell 704A or a PRACH to request SIB1 712B to the second NES cell 704B. In response to the PRACH to request SIB1 712A to the first NES cell 704A or the PRACH to request SIB1 712B to the second NES cell 704B, the first NES cell 704A or the second NES cell 704B may respond with SIB1 714A or SIB1 714B.

In some aspects, before sending PRACH request to a target NES cell for OD-SIB1, under specified conditions, the UE may acquire MIB/SIB1 of an associated cell A of the target NES cell, check validity of stored UL-WUS configuration for the target NES cell, and acquire the updated SIB X of the associated cell A if the stored UL-WUS configuration is not valid. In some examples, an associated cell A of the target NES cell is a known cell A of the target NES cell. A known cell A of the target NES cell is a cell A that was acquired by UE before and the UE has valid stored parameters for the cell A, e.g., (PCI, carrier frequency), MIB, SIB1, SIB X with UL-WUS configuration for the target NES cell. If there are multiple known cell As of the target NES cell, priority rules can be applied to select a known cell A with highest priority. If acquisition of the first selected cell A is failed, then the one with the next highest priority may be attempted. In some aspects, the priority rules may be based on signal quality and/or last acquisition time of cell As. For example, the cell A with higher detected reference signal received power (RSRP) or reference signal received quality (RSRQ) level may have higher priority. As another example, the cell A associated with the latest acquired SIB X and with detected RSRP/RSRQ above a threshold may have a higher priority. In some example, an associated cell A of the target NES cell may a known cell A of the target NES cell or an unknown cell A of the target NES cell. For example, if there is no known cell A of the NES cell, the UE may search for a new cell A associated with this NES cell. In some aspects, to acquire the associated cell A of the target NES cell, there may be no imposed conditions and up to UE's implementation. In some aspects, to acquire the associated cell A of the target NES cell, the condition may be that the camped cell does not carry the UL-WUS configuration for the target NES cell in one of its SIBs. In some aspects, to acquire the associated cell A of the target NES cell, the condition may be that the camped cell does not carry a change indication to indicate the change of UL-WUS configuration for the target NES cell. In some aspects, the stored SIB X may carry UL-WUS configuration for one or more NES cells, and the target NES cell is one of the one or more NES cells indicated in the stored SIB X.

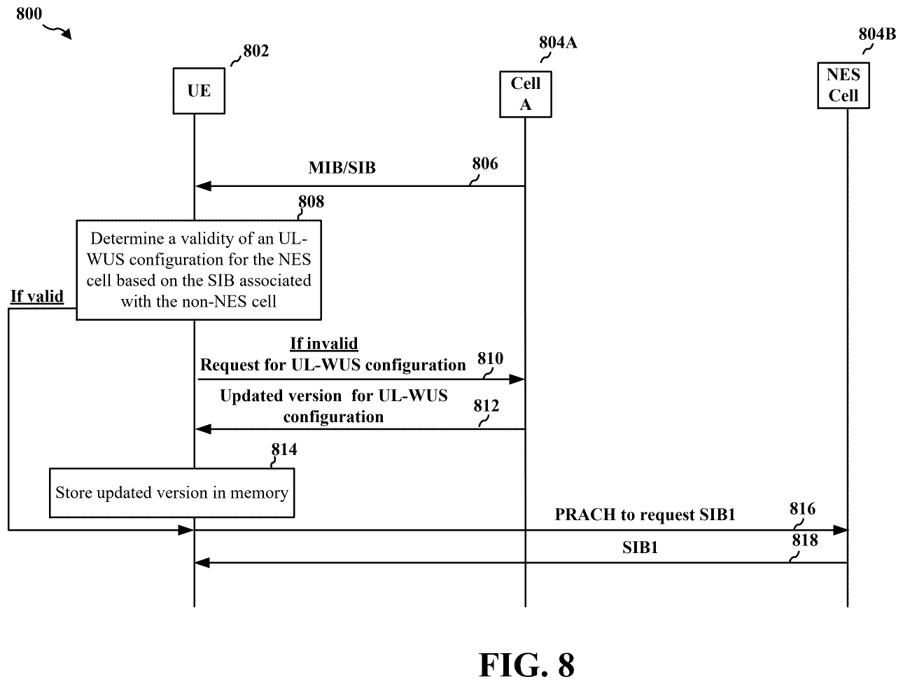

FIG. 8 is a diagram 800 illustrating example communications between a UE 802, a non-NES cell 804A, and an NES cell 804B. The non-NES cell 804A may be associated with the NES cell 804B. As illustrated in FIG. 8, the UE 802 may acquire MIB/SIB 806 of the non-NES cell 804A. The UE 802 may be camped on the non-NES cell 804A or camped on a different cell. In some aspects, the UE 802 may acquire MIB/SIB 806 of the non-NES cell 804A so that the UE 802 may select the NES cell 804B during cell reselection and transmit PRACH to request SIB1 816 to the NES cell 804B. In some aspects, at 808, the UE 802 may determine a validity of an UL-WUS configuration for the NES cell 804B based on the SIB associated with the non-NES cell 804A. If the UL-WUS configuration is valid, the UE 802 may send a PRACH to request SIB1 816 based on the valid UL-WUS configuration to the NES cell 804B and receive a SIB1 818 in response to the PRACH to request SIB1 816. If the UL-WUS configuration is invalid, the UE 802 may send a request for UL-WUS configuration 810 to the non-NES cell 804A and receive an updated version for the UL-WUS configuration 812 from the non-NES cell 804A. If the UL-WUS configuration is valid, the UE 802 may skip sending a request for UL-WUS configuration 810 and may send the PRACH to request SIB1 816 based on the valid UL-WUS configuration to the NES cell 804B and receive a SIB1 818 in response to the PRACH to request SIB1 816. In some aspects, the UE 802 may receive an updated version for the UL-WUS configuration 812 without transmitting the request for UL-WUS configuration 810 (e.g., the updated version for the UL-WUS configuration 812 may be configured to be periodically transmitted).

In some aspects, rules for cell selection/reselection procedure related to NES cells may be introduced to avoid the potential failure scenarios during cell selection/reselection procedure. In some aspects, initial cell selection, the UE may not select an NES cell. For example, the UE may ignore all detected NES cells during initial cell selection. In some aspects, for cell reselection from a camped cell to a target cell, if the camped cell is a cell A: the UE may (1) allowed to move from non-NES cell to another non-NES cell and (2) allowed to move from non-NES cell to NES cells associated with the non-NES cell. If the UE attempts to move from cell A to NES cells not associated with the non-NES cell, in some aspects, the UE may not be allowed to do so. If the UE attempts to move from cell A to NES cells not associated with the non-NES cell, in some aspects, the UE may follow the procedure of acquiring MIB/SIB described in connection with FIG. 8. If the UE attempts to move from cell A to NES cells not associated with the non-NES cell, in some aspects, the UE may follow the procedure with a lower priority than the case with target cell being a non-NES cell or being an NES cell associated with the cell A.

In some aspects, if the camped cell of the UE is an NES cell, the UE may be allowed to move to a non-NES cell. If the UE attempts to move to another NES cell when the camped cell of the UE is an NES cell, in some aspects, the UE may not be allowed to do so. If the UE attempts to move to another NES cell when the camped cell of the UE is an NES cell, in some aspects, the UE may attempt this with a lower priority than the case with target cell being a non-NES cell. If the UE attempts to move to another NES cell when the camped cell of the UE is an NES cell, in some aspects, the UE may follow the procedure of acquiring MIB/SIB described in connection with FIG. 8.

In some aspects, various rules may be defined for cell selection/reselection based on NES-type of the camped cell and/or the target cell and/or their association regarding UL-WUS configuration. In some aspects, the rules may include one or more of the following: (1) the target cell may not (or may be subjected to a lower priority) be an NES cell for initial cell selection and/or (cell reselection if meeting specified conditions), (2) a target NES cell is excluded (or may be subjected to a lower priority) from cell reselection, e.g., by being included in the blacklisted/excluded list of the camped cell, if specified conditions are met, (3) for cell selection/reselection, the priority for selecting a target cell being a non-NES cell is higher than being an NES cell, (4) for cell reselection, the priority for selecting a target cell being an NES cell associated with the camped cell (i.e., its UL-WUS configuration is transmitted by the camped cell) is higher than an NES cell not associated with the camped cell, (5) for cell reselection to a target NES cell, UE may acquire a known cell A associated with the target NES cell as proposal2, if specified conditions are met, or (6) cell reselection to a target NES cell, it is up to UE's implementation to determine whether to acquire a known cell A associated with the target NES cell as described in connection with FIG. 8, if specified conditions are met. In some aspects, the specified conditions may be one or more of: (1) no imposed condition (none), (2) the camp cell does not carry UL-WUS configuration for the target NES cell, (3) the camp cell does not carry a change indication to indicate the change of UL-WUS configuration for the target NES cell, or (4) both the camped cell the target cell are NES cells.

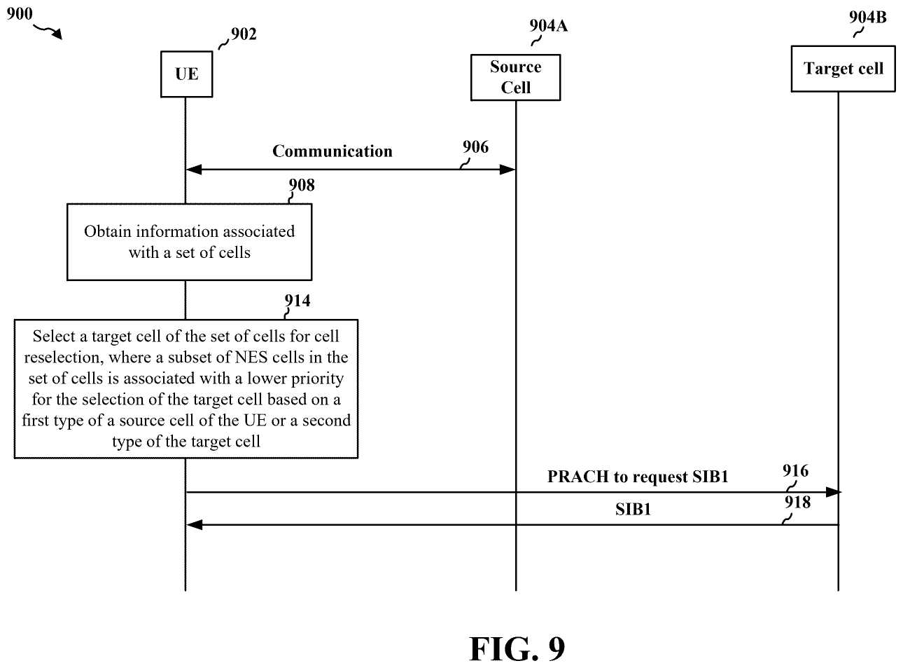

FIG. 9 is a diagram 900 illustrating example communications between a UE 902, a source cell 904A, and a target cell 904B. As illustrated in FIG. 9, the UE 902 may be in communication 906 with the source cell 904A. In some aspects, at 908, the UE 902 may obtain information associated with a set of cells. In some aspects, at 914, the UE 902 may select a target cell 904B of the set of cells for cell reselection, where a subset of NES cells in the set of cells is associated with a lower priority for the selection of the target cell based on a first type of a source cell of the UE or a second type of the target cell. The selection at 914 may follow the rules described herein. In some aspects, the rules may include one or more of the following: (1) the target cell may not (or may be subjected to a lower priority) be an NES cell for initial cell selection and/or (cell reselection if meeting specified conditions), (2) a target NES cell is excluded (or may be subjected to a lower priority) from cell reselection, e.g., by being included in the blacklisted/excluded list of the camped cell, if specified conditions are met, (3) for cell selection/reselection, the priority for selecting a target cell being a non-NES cell is higher than being an NES cell, (4) for cell reselection, the priority for selecting a target cell being an NES cell associated with the camped cell (i.e., its UL-WUS configuration is transmitted by the camped cell) is higher than an NES cell not associated with the camped cell, (5) for cell reselection to a target NES cell, UE may acquire a known cell A associated with the target NES cell as proposal2, if specified conditions are met, or (6) cell reselection to a target NES cell, it is up to UE's implementation to determine whether to acquire a known cell A associated with the target NES cell as described in connection with FIG. 8, if specified conditions are met. In some aspects, the specified conditions may be one or more of: (1) no imposed condition (none), (2) the camp cell does not carry UL-WUS configuration for the target NES cell, (3) the camp cell does not carry a change indication to indicate the change of UL-WUS configuration for the target NES cell, or (4) both the camped cell the target cell are NES cells. In some aspects, the UE 902 may transmit a PRACH to request SIB1 916 to the target cell 904B (e.g., based on a UL-WUS configuration associated with the target cell 904B), which is selected based on the rules. In response to the PRACH to request SIB1 916 to the target cell 904B, the target cell 904B may respond with SIB1 918.

In some aspects, the UE may store and manage known associated cell As with associated parameters for one or more NES cells based on received SIB X from cell As. In some aspects, upon reception of SIB X from a cell A, for an NES cell indicated with parameters (e.g., PCI, carrier frequency, or the like) in SIB X, the UE may check whether the acquired cell A is already included in the stored set of associated cell As for the NES cell. If not, the UE may add this acquired cell A to the set along with its associated parameters. If yes, the UE may update one or more associated parameters. The associated parameters of a cell A may be one or more of the following: PCI, carrier frequency, PLMN, cell identity, valueTag of SIB X, area scope, system information area ID, UL-WUS configuration for the NES cell from SIB X, time of acquisition, RSRP/RSRQ threshold, priority, or the like. Some of the parameters may be acquired from SSB or SIB1 or SIB X of the cell A. The UE may check whether a cell A is included in the stored set of associated cell As for an NES cell is based on a combination of parameters, such as (PCI and carrier frequency) or (PLMN and cell identity) of the cell A. The UE may delete an associated cell A for an NES cell from the stored set if the stored time exceed a max time and/or if the stored SIB X of the associated cell A is deleted. A UE may store an association table between parameters and cells, such as the examples below:

```
NES1(PCI1, carrierFreq1):
  1. cell A1 (PCI′, carrierFreq′)
  2. cell A2 (...)
  3. ...
NES2(PCI2, carrierFreq2):
```

Another example of the association table is provided below:

NES1(PCI1, carrierFreq1):

| | |
|---|---|
| 1. | cell A1 (PCI′, carrierFreq′, PLMN, cellIdentity, valueTag of SIB X, the |
| | IE areaScope, IE systemInformationAreaID, UL-WUS configuration for |
| | NES1) |
| 2. | cell A2 (...) |
| 3. | ... |

NES2(PCI2, carrierFreq2):
...

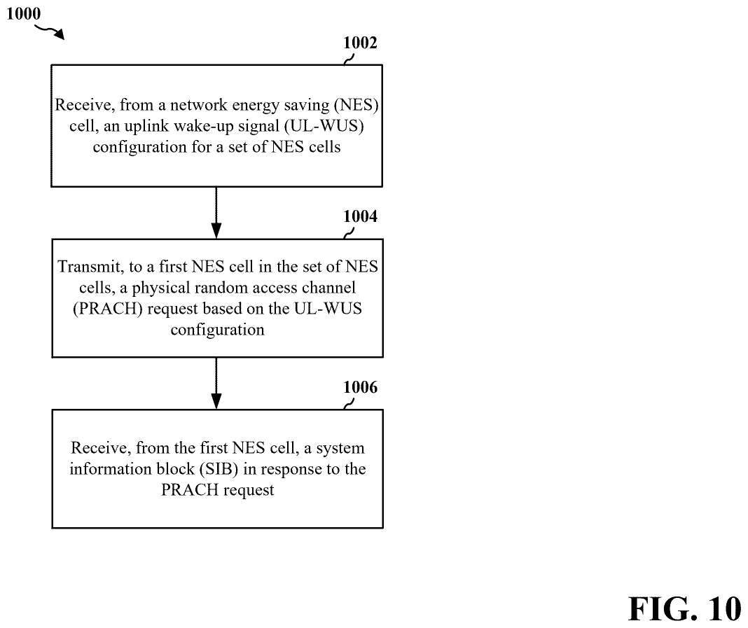

FIG. 10 is a flowchart 1000 of a method of wireless communication. The method may be performed by a UE (e.g., the UE 104, the UE 702; the apparatus 1104).

At 1002, the UE may receive, from an NES cell, an UL-WUS configuration for a set of NES cells. For example, the UE 702 may receive, from an NES cell 704A, an UL-WUS configuration for a set of NES cells (e.g., 704A and 704B). In some aspects, 1002 may be performed by WUS component 198.

In some aspects, to receive the UL-WUS configuration, the UE 702 may: receive the UL-WUS configuration (e.g., 706) in a second SIB or an RRC release message; and store the UL-WUS configuration in the at least one memory. In some aspects, the set of NES cells includes the NES cell and one or more neighboring NES cells of the NES cell. In some aspects, the set of NES cells includes the NES cell and one or more non-neighboring NES cells of the NES cell. In some aspects, the set of NES cells does not include the NES cell.

In some aspects, the set of NES cells includes the NES cell, the UE 702 may receive the UL-WUS configuration 706 for the NES cell in a first message (e.g., 706A), and receive an indication (e.g., 706B) of the UL-WUS configuration 706 for a remainder of the set of NES cells in a second message, where the indication indicates at least one of: (1) whether the UL-WUS configuration for the NES cell is applicable to the remainder of the set of NES cells, (2) a list of frequencies where the UL-WUS configuration for the NES cell is applicable, (3) a list of cell identifiers and carrier frequencies where the UL-WUS configuration for the NES cell is applicable, (4) a delta configuration of the UL-WUS configuration for the NES cell associated with the remainder of the set of NES cells, or an index of parameters associated with the remainder of the set of NES cells. In some aspects, the set of NES cells includes the NES cell, and where the UL-WUS configuration for the set of NES cells includes the UL-WUS configuration for the NES cell and one of: (1) the UL-WUS configuration for a remainder of the set of NES cells, or (2) an indication of the UL-WUS configuration for the remainder of the set of NES cells. In some aspects, the indication indicates at least one of: (1) whether the UL-WUS configuration for the NES cell is applicable to the remainder of the set of NES cells, (2) a list of frequencies where the UL-WUS configuration for the NES cell is applicable, (3) a list of cell identifiers and carrier frequencies where the UL-WUS configuration for the NES cell is applicable, (4) a delta configuration of the UL-WUS configuration for the NES cell associated with the remainder of the set of NES cells, or an index of parameters associated with the remainder of the set of NES cells. In some aspects, whether the UL-WUS configuration for the NES cell is applicable to the remainder of the set of NES cells is represented by one bit. In some aspects, the indication indicates the list of frequencies where the UL-WUS configuration for the NES cell is applicable, the delta configuration of the UL-WUS configuration for the NES cell associated with the remainder of the set of NES cells, and the index of parameters associated with the remainder of the set of NES cells. In some aspects, the indication indicates the list of cell identifiers and carrier frequencies where the UL-WUS configuration for the NES cell is applicable, the delta configuration of the UL-WUS configuration for the NES cell associated with the remainder of the set of NES cells, and the index of parameters associated with the remainder of the set of NES cells.

At 1004, the UE may transmit, to a first NES cell in the set of NES cells, a PRACH request based on the UL-WUS configuration. For example, the UE 702 may transmit, to a first NES cell (e.g., 704A or 704B) in the set of NES cells, a PRACH request (e.g., 712A or 712B) based on the UL-WUS configuration. In some aspects, 1004 may be performed by WUS component 198.

At 1006, the UE may receive, from the first NES cell, a SIB in response to the PRACH request. For example, the UE 702 may receive, from the first NES cell (e.g., 704A or 704B), a SIB (e.g., 714A or 714B) in response to the PRACH request. In some aspects, 1006 may be performed by WUS component 198.

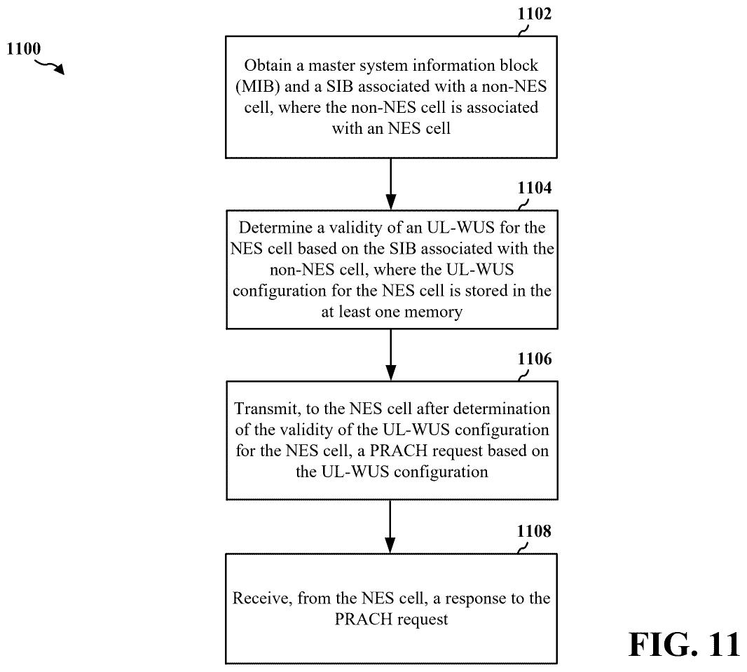

FIG. 11 is a flowchart 1100 of a method of wireless communication. The method may be performed by a UE (e.g., the UE 104, the UE 802; the apparatus 1104).

At 1102, the UE may obtain a MIB and a SIB associated with a non-NES cell, where the non-NES cell is associated with an NES cell. For example, the UE 802 may obtain a MIB and a SIB (e.g., 806) associated with a non-NES cell 804A, where the non-NES cell is associated with an NES cell 804B. In some aspects, 1102 may be performed by WUS component 198. In some aspects, the UE (e.g., 802) may obtain the MIB and the SIB (e.g., 806) and the UL-WUS configuration from the non-NES cell (e.g., 804A) based on a lack of the UL-WUS configuration transmitted from a cell on which the UE is camped.

At 1104, the UE may determine a validity of an UL-WUS configuration for the NES cell based on the SIB associated with the non-NES cell, where the UL-WUS configuration for the NES cell is stored in the at least one memory. For example, the UE 802 may determine (e.g., at 808) a validity of an UL-WUS configuration for the NES cell based on the SIB associated with the non-NES cell, where the UL-WUS configuration for the NES cell is stored in the at least one memory (e.g., at the UE 802). In some aspects, 1104 may be performed by WUS component 198.

In some aspects, the UE (e.g., 802) may, based on the UL-WUS configuration stored in the at least one memory is determined to be invalid, receive an updated version (e.g., 812) of the UL-WUS configuration for the NES cell from the non-NES cell, and store (e.g., 814) the updated version in the at least one memory. In some aspects, the UE (e.g., 802) may transmit, based on the UL-WUS configuration stored in the at least one memory being determined to be invalid, a request (e.g., 810) to the non-NES cell for the UL-WUS configuration before reception of the updated version (e.g., 812) of the UL-WUS configuration for the NES cell.

At 1106, the UE may transmit, to the NES cell after determination of the validity of the UL-WUS configuration for the NES cell, a PRACH request based on the UL-WUS configuration. For example, the UE 802 may transmit, to the NES cell 804B after determination of the validity of the UL-WUS configuration for the NES cell, a PRACH request (e.g., 816) based on the UL-WUS configuration. In some aspects, 1106 may be performed by WUS component 198.

At 1108, the UE may receive, from the NES cell, a response to the PRACH request. For example, the UE 802 may receive, from the NES cell, a response (e.g., 818) to the PRACH request (e.g., 816). In some aspects, 1108 may be performed by WUS component 198.

In some aspects, the UE (e.g., 802) may receive the UL-WUS configuration for the NES cell in a SIB X associated with a set of cells including the NES cell, where the SIB X indicates an identifier and a carrier frequency associated with the NES cell.

The UE (e.g., 802) may update or add (e.g., at 814) one or more parameters associated with the UL-WUS configuration (e.g., 812) for the NES cell in the at least one memory, where the one or more parameters include at least one of: the identifier, the carrier frequency, a public land mobile network (PLMN) associated with the NES cell, a cell identity associated with the NES cell, a value tag associated with the SIB X, an area scope associated with the NES cell, a system information area ID associated with the NES cell, a time of acquisition associated with reception of the SIB X, a measurement threshold associated with the NES cell, or a priority associated with the NES cell. In some aspects, the UE (e.g., 802) may determine whether the NES cell is associated with a particular non-NES cell in the at least one memory and delete information of the particular non-NES cell based on the particular non-NES cell being associated with the time of acquisition that exceeds a maximum time. In some aspects, the UE (e.g., 802) may obtain the MIB and the SIB (e.g., 806) after deletion of the information of the particular non-NES cell.

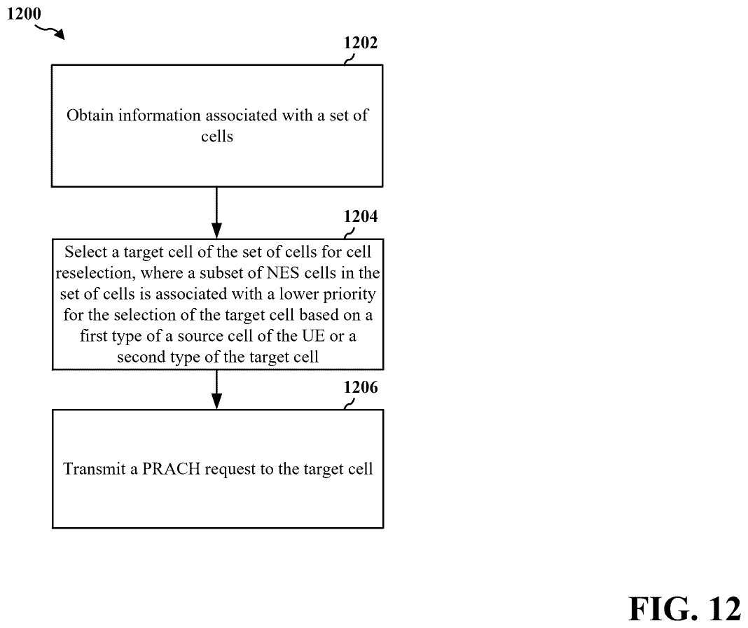

FIG. 12 is a flowchart 1200 of a method of wireless communication. The method may be performed by a UE (e.g., the UE 104, the UE 902; the apparatus 1104).

At 1202, the UE may obtain information associated with a set of cells. For example, the UE 902 may obtain (e.g., at 906) information associated with a set of cells. In some aspects, 1202 may be performed by WUS component 198.

At 1204, the UE may select a target cell of the set of cells for cell reselection, where a subset of NES cells in the set of cells is associated with a lower priority for the selection of the target cell based on a first type of a source cell of the UE or a second type of the target cell. For example, the UE 902 may select (e.g., at 814) a target cell (e.g., 904B) of the set of cells for cell reselection, where a subset of NES cells in the set of cells is associated with a lower priority for the selection of the target cell based on a first type of a source cell (e.g., 904A) of the UE or a second type of the target cell. In some aspects, 1204 may be performed by WUS component 198.

In some aspects, the second type of the target cell is an NES cell for initial cell selection or cell re-selection based on a condition associated with the UE, where the condition includes at least one of: (1) the source cell does not carry a UL-WUS configuration for the target cell, (2) the source cell does not carry a change indication to indicate a change of the UL-WUS configuration for the target cell, or (3) the first type of the source cell is the NES cell and the second type of the target cell is the NES cell. In other words, if the target cell is an NES cell for initial cell selection or cell re-selection and if the condition is satisfied, that particular target cell may have a less priority for initial cell selection or cell re-selection.

In some aspects, the second type of the target cell is an excluded cell in a blacklist associated with the source cell of the UE based on a condition associated with the UE, where the condition includes at least one of: (1) the source cell does not carry a UL-WUS configuration for the target cell, (2) the source cell does not carry a change indication to indicate a change of the UL-WUS configuration for the target cell, or (3) the first type of the source cell is the NES cell and the second type of the target cell is the NES cell. In other words, if the target cell is an excluded cell in a blacklist associated with the source cell of the UE and if the condition is satisfied, that particular target cell may have a less priority for initial cell selection or cell re-selection.

In some aspects, for the selection of the target cell, a first target cell that is a non-NES cell has a lower priority than a second target cell that is an NES cell. In other words, if the target cell is a non-NES cell, that particular target cell may have a less priority for initial cell selection or cell re-selection.

In some aspects, for the selection of the target cell, a first target cell that is associated with a first UL-WUS configuration not indicated by the source cell has a lower priority than a second target cell that is associated with a second UL-WUS configuration indicated by the source cell. In other words, if the target cell is an NES cell not associated with the source cell, where a UL-WUS configuration for the target NES cell is not indicated by the source cell, that particular target cell may have a less priority for initial cell selection or cell re-selection.

In some aspects, to select the target cell, the UE may, based on a condition associated with the UE, obtain a MIB and a SIB of a non-NES cell associated with the target cell, where the condition includes at least one of: (1) the source cell does not carry a UL-WUS configuration for the target cell, (2) the source cell does not carry a change indication to indicate a change of the UL-WUS configuration for the target cell, or (3) the first type of the source cell is the NES cell and the second type of the target cell is the NES cell. In some aspects, the non-NES cell is a known non-NES cell associated with the target cell.

At 1206, the UE may transmit a PRACH request to the target cell. For example, the UE 902 may transmit a PRACH request (e.g., 916) to the target cell. In some aspects, 1206 may be performed by WUS component 198.

In some aspects, the UE may receive a UL-WUS configuration for the target cell in a SIB X associated with the target cell, where the SIB X indicates an identifier and a carrier frequency associated with the target cell. In some aspects, the UE may update or add one or more parameters associated with the UL-WUS configuration for the target cell in the at least one memory, where the one or more parameters include at least one of: the identifier, the carrier frequency, a public land mobile network (PLMN) associated with the target cell, a cell identity associated with the target cell, a value tag associated with the SIB X, an area scope associated with the target cell, a system information area ID associated with the target cell, a time of acquisition associated with reception of the SIB X, a measurement threshold associated with the target cell, or a priority associated with the target cell.

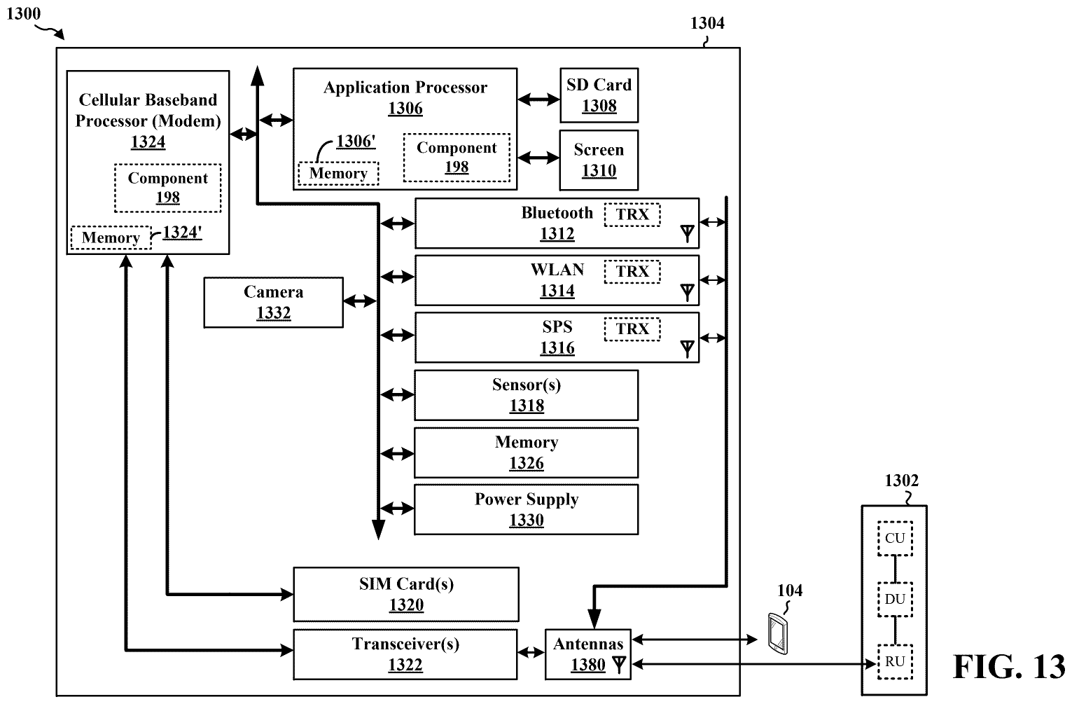

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, NES cells. In some aspects, the WUS component 198 may be configured to transmit, to a first NES cell in the set of NES cells, a physical random access channel (PRACH) request based on the UL-WUS configuration. In some aspects, the WUS component 198 may be configured to receive, from the first NES cell, a system information block (SIB) in response to the PRACH request.

In some aspects, the WUS component 198 may be configured to obtain a master information block (MIB) and a system information block (SIB) associated with a non-network energy saving (NES) cell, where the non-NES cell is associated with an NES cell. In some aspects, the WUS component 198 may be configured to determine a validity of an uplink wake-up signal (UL-WUS) configuration for the NES cell based on the SIB associated with the non-NES cell, where the UL-WUS configuration for the NES cell is stored in the at least one memory. In some aspects, the WUS component 198 may be configured to transmit, to the NES cell after determination of the validity of the UL-WUS configuration for the NES cell, a physical random access channel (PRACH) request based on the UL-WUS configuration. In some aspects, the WUS component 198 may be configured to receive, from the NES cell, a response to the PRACH request.

In some aspects, the WUS component 198 may be configured to obtain information associated with a set of cells. In some aspects, the WUS component 198 may be configured to select a target cell of the set of cells for cell reselection, where a subset of network energy saving (NES) cells in the set of cells is associated with a lower priority for the selection of the target cell based on a first type of a source cell of the UE or a second type of the target cell. In some aspects, the WUS component 198 may be configured to transmit a physical random access channel (PRACH) request to the target cell. The WUS component 198 may be within the cellular baseband processor(s) 1324, the application processor(s) 1306, or both the cellular baseband processor(s) 1324 and the application processor(s) 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for receiving, from a network energy saving (NES) cell, an uplink wake-up signal (UL-WUS) configuration for a set of NES cells. In some aspects, the apparatus 1304 may include means for transmitting, to a first NES cell in the set of NES cells, a physical random access channel (PRACH) request based on the UL-WUS configuration. In some aspects, the apparatus 1304 may include means for receiving, from the first NES cell, a system information block (SIB) in response to the PRACH request. In some aspects, the apparatus 1304 may include means for receiving the UL-WUS configuration in a second SIB or a radio resource control (RRC) release message. In some aspects, the apparatus 1304 may include means for storing the UL-WUS configuration in the at least one memory. In some aspects, the apparatus 1304 may include means for receiving the UL-WUS configuration for the NES cell in a first message. In some aspects, the apparatus 1304 may include means for receiving an indication of the UL-WUS configuration for a remainder of the set of NES cells in a second message, where the indication indicates at least one of: (1) whether the UL-WUS configuration for the NES cell is applicable to the remainder of the set of NES cells, (2) a list of frequencies where the UL-WUS configuration for the NES cell is applicable, (3) a list of cell identifiers and carrier frequencies where the UL-WUS configuration for the NES cell is applicable, (4) a delta configuration of the UL-WUS configuration for the NES cell associated with the remainder of the set of NES cells, or an index of parameters associated with the remainder of the set of NES cells. In some aspects, the apparatus 1304 may include means for obtaining a master information block (MIB) and a system information block (SIB) associated with a non-network energy saving (NES) cell, where the non-NES cell is associated with an NES cell. In some aspects, the apparatus 1304 may include means for determining a validity of an uplink wake-up signal (UL-WUS) configuration for the NES cell based on the SIB associated with the non-NES cell, where the UL-WUS configuration for the NES cell is stored in the at least one memory. In some aspects, the apparatus 1304 may include means for transmitting, to the NES cell after determination of the validity of the UL-WUS configuration for the NES cell, a physical random access channel (PRACH) request based on the UL-WUS configuration. In some aspects, the apparatus 1304 may include means for receiving, from the NES cell, a response to the PRACH request. In some aspects, the apparatus 1304 may include means for based on the UL-WUS configuration stored in the at least one memory being determined to be invalid, receiving an updated version of the UL-WUS configuration for the NES cell from the non-NES cell, and store the updated version in the at least one memory. In some aspects, the apparatus 1304 may include means for transmitting, based on the UL-WUS configuration stored in the at least one memory being determined to be invalid, a request to the non-NES cell for the UL-WUS configuration before reception of the updated version of the UL-WUS configuration for the NES cell. In some aspects, the apparatus 1304 may include means for obtaining the MIB and the SIB and the UL-WUS configuration from the non-NES cell based on a lack of the UL-WUS configuration transmitted from a cell on which the UE is camped. In some aspects, the apparatus 1304 may include means for obtaining the MIB and the SIB and the UL-WUS configuration for the NES cell from the non-NES cell based on a lack of change indication associated with the UL-WUS configuration from a cell on which the UE is camped. In some aspects, the apparatus 1304 may include means for receiving the UL-WUS configuration for the NES cell in a SIB X associated with a set of cells including the NES cell, where the SIB X indicates an identifier and a carrier frequency associated with the NES cell. In some aspects, the apparatus 1304 may include means for updating or adding one or more parameters associated with the UL-WUS configuration for the NES cell in the at least one memory, where the one or more parameters include at least one of: the identifier, the carrier frequency, a public land mobile network (PLMN) associated with the NES cell, a cell identity associated with the NES cell, a value tag associated with the SIB X, an area scope associated with the NES cell, a system information area ID associated with the NES cell, a time of acquisition associated with reception of the SIB X, a measurement threshold associated with the NES cell, or a priority associated with the NES cell. In some aspects, the apparatus 1304 may include means for determining whether the NES cell is associated with a particular non-NES cell in the at least one memory. In some aspects, the apparatus 1304 may include means for deleting information of the particular non-NES cell based on the particular non-NES cell being associated with the time of acquisition that exceeds a maximum time. In some aspects, the apparatus 1304 may include means for obtaining the MIB and the SIB after deletion of the information of the particular non-NES cell. In some aspects, the apparatus 1304 may include means for obtaining information associated with a set of cells. In some aspects, the apparatus 1304 may include means for selecting a target cell of the set of cells for cell reselection, where a subset of network energy saving (NES) cells in the set of cells is associated with a lower priority for the selection of the target cell based on a first type of a source cell of the UE or a second type of the target cell. In some aspects, the apparatus 1304 may include means for transmitting a physical random access channel (PRACH) request to the target cell. In some aspects, the apparatus 1304 may include means for based on a condition associated with the UE, obtaining a master information block (MIB) and a system information block (SIB) of a non-NES cell associated with the target cell, where the condition includes at least one of: (1) the source cell does not carry an uplink wake-up signal (UL-WUS) configuration for the target cell, (2) the source cell does not carry a change indication to indicate a change of the UL-WUS configuration for the target cell, or (3) the first type of the source cell is the NES cell and the second type of the target cell is the NES cell. In some aspects, the apparatus 1304 may include means for receiving an uplink wake-up signal (UL-WUS) configuration for the target cell in a system information block (SIB) X associated with the target cell, where the SIB X indicates an identifier and a carrier frequency associated with the target cell. In some aspects, the apparatus 1304 may include means for updating or adding one or more parameters associated with the UL-WUS configuration for the target cell in the at least one memory, where the one or more parameters include at least one of: the identifier, the carrier frequency, a public land mobile network (PLMN) associated with the target cell, a cell identity associated with the target cell, a value tag associated with the SIB X, an area scope associated with the target cell, a system information area ID associated with the target cell, a time of acquisition associated with reception of the SIB X, a measurement threshold associated with the target cell, or a priority associated with the target cell. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

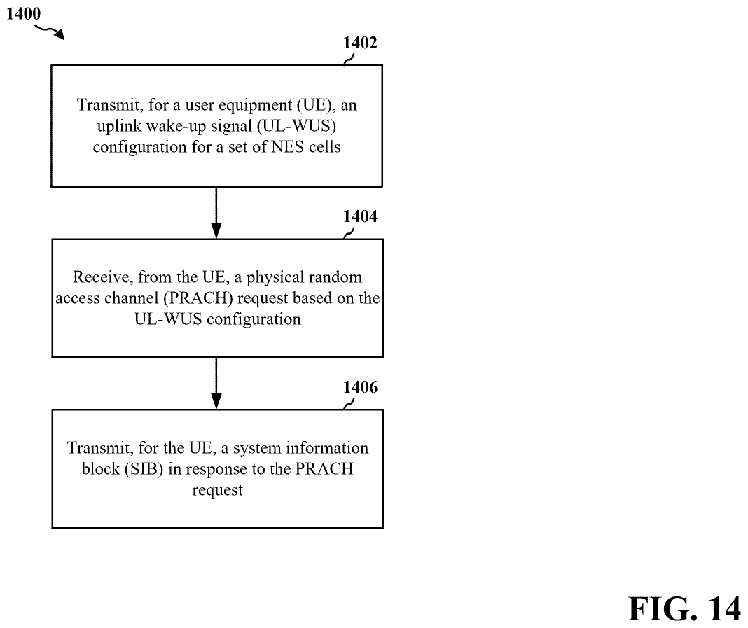

FIG. 14 is a flowchart 1400 of a method of wireless communication. The method may be performed by an NES cell (e.g., the base station 102, the first NES cell 704A, the network entity 1302, the network entity 1502).

At 1402, the NES cell may transmit, for a UE, an UL-WUS configuration for a set of NES cells. For example, the first NES cell 704A may transmit, for a UE, an UL-WUS configuration (e.g., 706) for a set of NES cells. In some aspects, 1402 may be performed by WUS component 199.

At 1404, the NES cell may receive, from the UE, a PRACH request based on the UL-WUS configuration. For example, the first NES cell 704A may receive, from the UE, a PRACH request (e.g., 712A) based on the UL-WUS configuration. In some aspects, 1404 may be performed by WUS component 199.

At 1406, the NES cell may transmit, for the UE, a SIB in response to the PRACH request. For example, the first NES cell 704A may transmit, for the UE (e.g., 702), a SIB (e.g., 714A) in response to the PRACH request. In some aspects, 1406 may be performed by WUS component 199.

In some aspects, the set of NES cells includes the NES cell, and where the UL-WUS configuration for the set of NES cells includes the UL-WUS configuration for the NES cell and one of: (1) the UL-WUS configuration for a remainder of the set of NES cells, or (2) an indication of the UL-WUS configuration for the remainder of the set of NES cells. In some aspects, the indication indicates at least one of: (1) whether the UL-WUS configuration for the NES cell is applicable to the remainder of the set of NES cells, (2) a list of frequencies where the UL-WUS configuration for the NES cell is applicable, (3) a list of cell identifiers and carrier frequencies where the UL-WUS configuration for the NES cell is applicable, (4) a delta configuration of the UL-WUS configuration for the NES cell associated with the remainder of the set of NES cells, or an index of parameters associated with the remainder of the set of NES cells. In some aspects, whether the UL-WUS configuration for the NES cell is applicable to the remainder of the set of NES cells is represented by one bit. In some aspects, the indication indicates the list of frequencies where the UL-WUS configuration for the NES cell is applicable, the delta configuration of the UL-WUS configuration for the NES cell associated with the remainder of the set of NES cells, and the index of parameters associated with the remainder of the set of NES cells. In some aspects, the indication indicates the list of cell identifiers and carrier frequencies where the UL-WUS configuration for the NES cell is applicable, the delta configuration of the UL-WUS configuration for the NES cell associated with the remainder of the set of NES cells, and the index of parameters associated with the remainder of the set of NES cells.

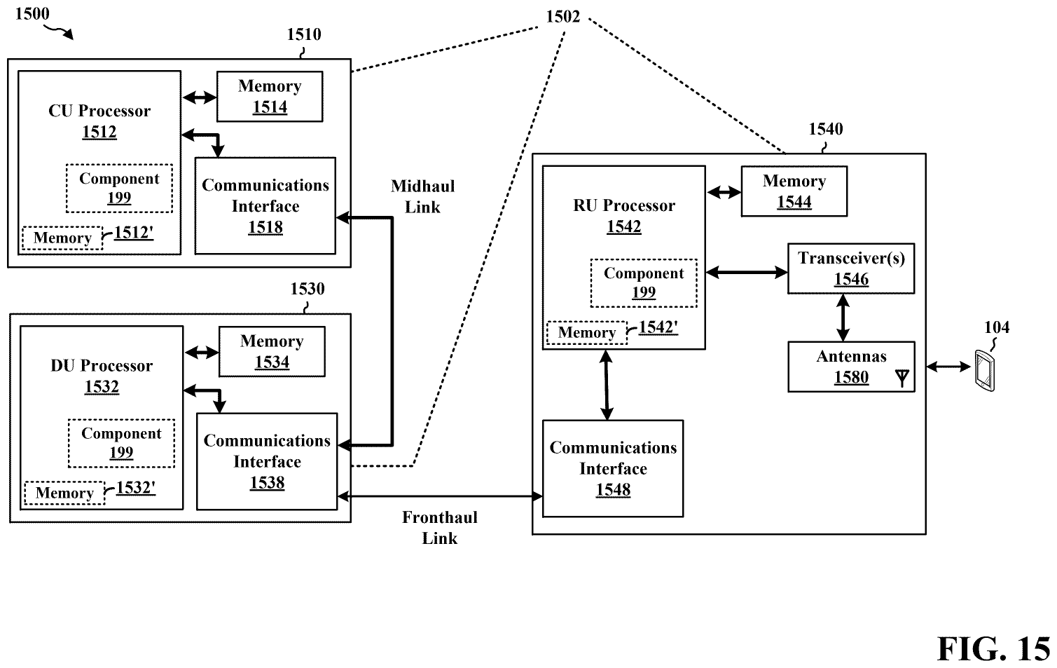

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the WUS component 199 may be configured to transmit, for a UE, an UL-WUS configuration for a set of NES cells. In some aspects, the WUS component 199 may be further configured to receive, from the UE, a PRACH request based on the UL-WUS configuration. In some aspects, the WUS component 199 may be further configured to transmit, for the UE, a SIB in response to the PRACH request. The WUS component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for transmitting, for a UE, an UL-WUS configuration for a set of NES cells. In some aspects, the network entity 1502 may include means for receiving, from the UE, a PRACH request based on the UL-WUS configuration. In some aspects, the network entity 1502 may include means for transmitting, for the UE, a SIB in response to the PRACH request. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for communication at a user equipment (UE), including: at least one memory; and at least one processor coupled to the at least one memory and, based at least in part on information stored in the at least one memory, the at least one processor is configured to: receive, from a network energy saving (NES) cell, an uplink wake-up signal (UL-WUS) configuration for a set of NES cells; transmit, to a first NES cell in the set of NES cells, a physical random access channel (PRACH) request based on the UL-WUS configuration; and receive, from the first NES cell, a system information block (SIB) in response to the PRACH request.

Aspect 2 is the apparatus of aspect 1, where to receive the UL-WUS configuration, the at least one processor is configured to: receive the UL-WUS configuration in a second SIB or a radio resource control (RRC) release message; and store the UL-WUS configuration in the at least one memory.

Aspect 3 is the apparatus of any of aspects 1-2, where the set of NES cells includes the NES cell and one or more neighboring NES cells of the NES cell.

Aspect 4 is the apparatus of any of aspects 1-2, where the set of NES cells includes the NES cell and one or more non-neighboring NES cells of the NES cell.

Aspect 5 is the apparatus of any of aspects 1-2, where the set of NES cells does not include the NES cell.

Aspect 6 is the apparatus of any of aspects 1-2, where the set of NES cells includes the NES cell, and where the set of NES cells includes the NES cell, and where the UL-WUS configuration for the set of NES cells includes the UL-WUS configuration for the NES cell and one of: (1) the UL-WUS configuration for a remainder of the set of NES cells, or (2) an indication of the UL-WUS configuration for the remainder of the set of NES cells, where the indication indicates at least one of: (1) whether the UL-WUS configuration for the NES cell is applicable to the remainder of the set of NES cells, (2) a list of frequencies where the UL-WUS configuration for the NES cell is applicable, (3) a list of cell identifiers and carrier frequencies where the UL-WUS configuration for the NES cell is applicable, (4) a delta configuration of the UL-WUS configuration for the NES cell associated with the remainder of the set of NES cells, or an index of parameters associated with the remainder of the set of NES cells, and where whether the UL-WUS configuration for the NES cell is applicable to the remainder of the set of NES cells is represented by one bit.

Aspect 7 is an apparatus for communication at a user equipment (UE), including: at least one memory; and at least one processor coupled to the at least one memory and, based at least in part on information stored in the at least one memory, the at least one processor is configured to: obtain a master information block (MIB) and a system information block (SIB) associated with a non-network energy saving (non-NES) cell, where the non-NES cell is associated with an NES cell; determine a validity of an uplink wake-up signal (UL-WUS) configuration for the NES cell based on the SIB associated with the non-NES cell, where the UL-WUS configuration for the NES cell is stored in the at least one memory; transmit, to the NES cell after determination of the validity of the UL-WUS configuration for the NES cell, a physical random access channel (PRACH) request based on the UL-WUS configuration; and receive, from the NES cell, a response to the PRACH request.

Aspect 8 is the apparatus of any of aspects 1-7, where, the at least one processor is further configured to: based on the UL-WUS configuration stored in the at least one memory being determined to be invalid, receive an updated version of the UL-WUS configuration for the NES cell from the non-NES cell, and store the updated version in the at least one memory.

Aspect 9 is the apparatus of aspect 8, where, the at least one processor is further configured to: transmit, based on the UL-WUS configuration stored in the at least one memory being determined to be invalid, a request to the non-NES cell for the UL-WUS configuration before reception of the updated version of the UL-WUS configuration for the NES cell.

Aspect 10 is the apparatus of any of aspects 1-9, where to obtain the MIB and the SIB, the at least one processor is configured to: obtain the MIB and the SIB and the UL-WUS configuration from the non-NES cell based on a lack of the UL-WUS configuration transmitted from a cell on which the UE is camped.

Aspect 11 is the apparatus of any of aspects 1-8, where to obtain the MIB and the SIB, the at least one processor is configured to: obtain the MIB and the SIB and the UL-WUS configuration for the NES cell from the non-NES cell based on a lack of change indication associated with the UL-WUS configuration from a cell on which the UE is camped.

Aspect 12 is the apparatus of any of aspects 1-10, where the at least one processor is further configured to: receive the UL-WUS configuration for the NES cell in a SIB X associated with a set of cells including the NES cell, where the SIB X indicates an identifier and a carrier frequency associated with the NES cell; and update or add one or more parameters associated with the UL-WUS configuration for the NES cell in the at least one memory, where the one or more parameters include at least one of: the identifier, the carrier frequency, a public land mobile network (PLMN) associated with the NES cell, a cell identity associated with the NES cell, a value tag associated with the SIB X, an area scope associated with the NES cell, a system information area ID associated with the NES cell, a time of acquisition associated with reception of the SIB X, a measurement threshold associated with the NES cell, or a priority associated with the NES cell.

Aspect 13 is the apparatus of aspect 12, where the at least one processor is further configured to: determine whether the NES cell is associated with a particular non-NES cell in the at least one memory; and delete information of the particular non-NES cell based on the particular non-NES cell being associated with the time of acquisition that exceeds a maximum time.

Aspect 14 is the apparatus of aspect 13, where to obtain the MIB and the SIB, the at least one processor is configured to: obtain the MIB and the SIB after deletion of the information of the particular non-NES cell.

Aspect 15 is an apparatus for communication at a user equipment (UE), including: at least one memory; and at least one processor coupled to the at least one memory and, based at least in part on information stored in the at least one memory, the at least one processor is configured to: obtain information associated with a set of cells; select a target cell of the set of cells for cell reselection, where a subset of network energy saving (NES) cells in the set of cells is associated with a lower priority for the selection of the target cell based on a first type of a source cell of the UE or a second type of the target cell; and transmit a physical random access channel (PRACH) request to the target cell.

Aspect 16 is the apparatus of any of aspects 1-15, where the second type of the target cell is an NES cell for initial cell selection or cell re-selection based on a condition associated with the UE, where the condition includes at least one of: (1) the source cell does not carry an uplink wake-up signal (UL-WUS) configuration for the target cell, (2) the source cell does not carry a change indication to indicate a change of the UL-WUS configuration for the target cell, or (3) the first type of the source cell is the NES cell and the second type of the target cell is the NES cell.

Aspect 17 is the apparatus of any of aspects 1-15, where the second type of the target cell is an excluded cell in a blacklist associated with the source cell of the UE based on a condition associated with the UE, where the condition includes at least one of: (1) the source cell does not carry an uplink wake-up signal (UL-WUS) configuration for the target cell, (2) the source cell does not carry a change indication to indicate a change of the UL-WUS configuration for the target cell, or (3) the first type of the source cell is the NES cell and the second type of the target cell is the NES cell.

Aspect 18 is the apparatus of any of aspects 1-15, where for the selection of the target cell, a first target cell that is a non-NES cell has a lower priority than a second target cell that is an NES cell.

Aspect 19 is the apparatus of any of aspects 1-15, where for the selection of the target cell, a first target cell that is associated with a first uplink wake-up signal (UL-WUS) configuration not indicated by the source cell has a lower priority than a second target cell that is associated with a second UL-WUS configuration indicated by the source cell.

Aspect 20 is the apparatus of any of aspects 1-19, where to select the target cell, the at least one processor is configured to: obtain, based on a condition associated with the UE, a master information block (MIB) and a system information block (SIB) of a non-NES cell associated with the target cell, where the condition includes at least one of: (1) the source cell does not carry an uplink wake-up signal (UL-WUS) configuration for the target cell, (2) the source cell does not carry a change indication to indicate a change of the UL-WUS configuration for the target cell, or (3) the first type of the source cell is the NES cell and the second type of the target cell is the NES cell.

Aspect 21 is the apparatus of aspect 20, where the at least one processor is further configured to: receive an uplink wake-up signal (UL-WUS) configuration for the target cell in a system information block (SIB) X associated with the target cell, where the SIB X indicates an identifier and a carrier frequency associated with the target cell; and update or add one or more parameters associated with the UL-WUS configuration for the target cell in the at least one memory, where the one or more parameters include at least one of: the identifier, the carrier frequency, a public land mobile network (PLMN) associated with the target cell, a cell identity associated with the target cell, a value tag associated with the SIB X, an area scope associated with the target cell, a system information area ID associated with the target cell, a time of acquisition associated with reception of the SIB X, a measurement threshold associated with the target cell, or a priority associated with the target cell.

Aspect 22 is a method of wireless communication for implementing any of aspects 1 to 21.

Aspect 23 is a computer-readable medium (e.g., a non-transitory computer-readable medium) storing computer executable code, the code when executed by at least one processor causes the at least one processor to implement any of aspects 1 to 21.

Aspect 24 is an apparatus comprising means for implementing any of aspects 1 to 21.

Aspect 25 is an apparatus for communication at a network energy saving (NES) cell, including: at least one memory; and at least one processor coupled to the at least one memory and, based at least in part on information stored in the at least one memory, the at least one processor is configured to: transmit, for a UE, an UL-WUS configuration for a set of NES cells; receive, from the UE, a PRACH request based on the UL-WUS configuration; and transmit, for the UE, a SIB in response to the PRACH request.

Aspect 26 is the apparatus of aspect 25, where to transmit the UL-WUS configuration, the at least one processor is configured to: transmit the UL-WUS configuration in a second SIB or a radio resource control (RRC) release message.

Aspect 27 is the apparatus of any of aspects 25-26, where the set of NES cells includes the NES cell and one or more neighboring NES cells of the NES cell.

Aspect 28 is the apparatus of any of aspects 25-26, where the set of NES cells includes the NES cell and one or more non-neighboring NES cells of the NES cell.

Aspect 29 is the apparatus of any of aspects 25-26, where the set of NES cells does not include the NES cell.

Aspect 30 is the apparatus of any of aspects 25-26, where the set of NES cells includes the NES cell, and where the UL-WUS configuration for the set of NES cells includes the UL-WUS configuration for the NES cell and one of: (1) the UL-WUS configuration for a remainder of the set of NES cells, or (2) an indication of the UL-WUS configuration for the remainder of the set of NES cells.

Aspect 31 is the apparatus of aspect 30, where the indication indicates at least one of: (1) whether the UL-WUS configuration for the NES cell is applicable to the remainder of the set of NES cells, (2) a list of frequencies where the UL-WUS configuration for the NES cell is applicable, (3) a list of cell identifiers and carrier frequencies where the UL-WUS configuration for the NES cell is applicable, (4) a delta configuration of the UL-WUS configuration for the NES cell associated with the remainder of the set of NES cells, or an index of parameters associated with the remainder of the set of NES cells.

Aspect 32 is the apparatus of aspect 31, where whether the UL-WUS configuration for the NES cell is applicable to the remainder of the set of NES cells is represented by one bit.

Aspect 33 is the apparatus of aspect 31, where the indication indicates the list of frequencies where the UL-WUS configuration for the NES cell is applicable, the delta configuration of the UL-WUS configuration for the NES cell associated with the remainder of the set of NES cells, and the index of parameters associated with the remainder of the set of NES cells.

Aspect 34 is the apparatus of aspect 31, where the indication indicates the list of cell identifiers and carrier frequencies where the UL-WUS configuration for the NES cell is applicable, the delta configuration of the UL-WUS configuration for the NES cell associated with the remainder of the set of NES cells, and the index of parameters associated with the remainder of the set of NES cells.

Aspect 35 is a method of wireless communication for implementing any of aspects 25 to 34.

Aspect 36 is a computer-readable medium (e.g., a non-transitory computer-readable medium) storing computer executable code, the code when executed by at least one processor causes the at least one processor to implement any of aspects 25 to 34.

Aspect 37 is an apparatus comprising means for implementing any of aspects 25 to 34.

What is claimed is:

1. An apparatus for communication at a user equipment (UE), comprising:
at least one memory; and
at least one processor coupled to the at least one memory and, based at least in part on information stored in the at least one memory, the at least one processor is configured to:
receive, from a network energy saving (NES) cell, an uplink wake-up signal (UL-WUS) configuration for a set of NES cells;
transmit, to a first NES cell in the set of NES cells, a physical random access channel (PRACH) request based on the UL-WUS configuration; and
receive, from the first NES cell, a system information block (SIB) in response to the PRACH request.

2. The apparatus of claim 1, wherein to receive the UL-WUS configuration, the at least one processor is configured to:
receive the UL-WUS configuration in a second SIB or a radio resource control (RRC) release message; and
store the UL-WUS configuration in the at least one memory.

3. The apparatus of claim 1, wherein the set of NES cells includes the NES cell and one or more neighboring NES cells of the NES cell.

4. The apparatus of claim 1, wherein the set of NES cells includes the NES cell and one or more non-neighboring NES cells of the NES cell.

5. The apparatus of claim 1, wherein the set of NES cells does not include the NES cell.

6. The apparatus of claim 1, wherein the set of NES cells includes the NES cell, and wherein the UL-WUS configuration for the set of NES cells includes the UL-WUS configuration for the NES cell and one of: (1) the UL-WUS configuration for a remainder of the set of NES cells, or (2) an indication of the UL-WUS configuration for the remainder of the set of NES cells.

7. The apparatus of claim 6, wherein the indication indicates at least one of: (1) whether the UL-WUS configuration for the NES cell is applicable to the remainder of the set of NES cells, (2) a list of frequencies where the UL-WUS configuration for the NES cell is applicable, (3) a list of cell identifiers and carrier frequencies where the UL-WUS configuration for the NES cell is applicable, (4) a delta configuration of the UL-WUS configuration for the NES cell associated with the remainder of the set of NES cells or an index of parameters associated with the remainder of the set of NES cells.

8. The apparatus of claim 7, wherein whether the UL-WUS configuration for the NES cell is applicable to the remainder of the set of NES cells is represented by one bit.

9. The apparatus of claim 7, wherein the indication indicates the list of frequencies where the UL-WUS configuration for the NES cell is applicable, the delta configuration of the UL-WUS configuration for the NES cell associated with the remainder of the set of NES cells, and the index of parameters associated with the remainder of the set of NES cells.

10. The apparatus of claim 7, wherein the indication indicates the list of cell identifiers and carrier frequencies where the UL-WUS configuration for the NES cell is applicable, the delta configuration of the UL-WUS configuration for the NES cell associated with the remainder of the set of NES cells, and the index of parameters associated with the remainder of the set of NES cells.

11. An apparatus for communication at a network energy saving (NES) cell, comprising:
at least one memory; and
at least one processor coupled to the at least one memory and, based at least in part on information stored in the at least one memory, the at least one processor is configured to:
transmit, for a user equipment (UE), an uplink wake-up signal (UL-WUS) configuration for a set of NES cells;
receive, from the UE, a physical random access channel (PRACH) request based on the UL-WUS configuration; and
transmit, for the UE, a system information block (SIB) in response to the PRACH request.

12. The apparatus of claim 11, wherein to transmit the UL-WUS configuration, the at least one processor is configured to:
transmit the UL-WUS configuration in a second SIB or a radio resource control (RRC) release message.

13. The apparatus of claim 11, wherein the set of NES cells includes the NES cell and one or more neighboring NES cells of the NES cell.

14. The apparatus of claim 11, wherein the set of NES cells includes the NES cell and one or more non-neighboring NES cells of the NES cell.

15. The apparatus of claim 11, wherein the set of NES cells does not include the NES cell.

16. The apparatus of claim 11, wherein the set of NES cells includes the NES cell, and wherein the UL-WUS configuration for the set of NES cells includes the UL-WUS configuration for the NES cell and one of: (1) the UL-WUS configuration for a remainder of the set of NES cells, or (2) an indication of the UL-WUS configuration for the remainder of the set of NES cells.

17. The apparatus of claim 16, wherein the indication indicates at least one of: (1) whether the UL-WUS configuration for the NES cell is applicable to the remainder of the set of NES cells, (2) a list of frequencies where the UL-WUS configuration for the NES cell is applicable, (3) a list of cell identifiers and carrier frequencies where the UL-WUS configuration for the NES cell is applicable, (4) a delta configuration of the UL-WUS configuration for the NES cell associated with the remainder of the set of NES cells or an index of parameters associated with the remainder of the set of NES cells.

18. The apparatus of claim 17, wherein whether the UL-WUS configuration for the NES cell is applicable to the remainder of the set of NES cells is represented by one bit.

19. The apparatus of claim 17, wherein the indication indicates the list of frequencies where the UL-WUS configuration for the NES cell is applicable, the delta configuration of the UL-WUS configuration for the NES cell associated with the remainder of the set of NES cells, and the index of parameters associated with the remainder of the set of NES cells.

20. The apparatus of claim 17, wherein the indication indicates the list of cell identifiers and carrier frequencies where the UL-WUS configuration for the NES cell is applicable, the delta configuration of the UL-WUS configuration for the NES cell associated with the remainder of the set of NES cells, and the index of parameters associated with the remainder of the set of NES cells.

21. A method of communication at a user equipment (UE), comprising:
receiving, from a network energy saving (NES) cell, an uplink wake-up signal (UL-WUS) configuration for a set of NES cells;
transmitting, to a first NES cell in the set of NES cells, a physical random access channel (PRACH) request based on the UL-WUS configuration; and
receiving, from the first NES cell, a system information block (SIB) in response to the PRACH request.

22. The method of claim 21, wherein the set of NES cells includes the NES cell, and wherein the UL-WUS configuration for the set of NES cells includes the UL-WUS configuration for the NES cell and one of: (1) the UL-WUS configuration for a remainder of the set of NES cells, or (2) an indication of the UL-WUS configuration for the remainder of the set of NES cells.

23. The method of claim 22, wherein the indication indicates at least one of: (1) whether the UL-WUS configuration for the NES cell is applicable to the remainder of the set of NES cells, (2) a list of frequencies where the UL-WUS configuration for the NES cell is applicable, (3) a list of cell identifiers and carrier frequencies where the UL-WUS configuration for the NES cell is applicable, (4) a delta configuration of the UL-WUS configuration for the NES cell associated with the remainder of the set of NES cells or an index of parameters associated with the remainder of the set of NES cells.

24. The method of claim 23, wherein whether the UL-WUS configuration for the NES cell is applicable to the remainder of the set of NES cells is represented by one bit.

25. The method of claim 23, wherein the indication indicates the list of frequencies where the UL-WUS configuration for the NES cell is applicable, the delta configuration of the UL-WUS configuration for the NES cell associated with the remainder of the set of NES cells, and the index of parameters associated with the remainder of the set of NES cells.

26. A method of communication at a network energy saving (NES) cell, comprising:
transmitting, for a user equipment (UE), an uplink wake-up signal (UL-WUS) configuration for a set of NES cells;
receiving, from the UE, a physical random access channel (PRACH) request based on the UL-WUS configuration; and
transmitting, for the UE, a system information block (SIB) in response to the PRACH request.

27. The method of claim 26, wherein the set of NES cells includes the NES cell, and wherein the UL-WUS configuration for the set of NES cells includes the UL-WUS configuration for the NES cell and one of: (1) the UL-WUS configuration for a remainder of the set of NES cells, or (2) an indication of the UL-WUS configuration for the remainder of the set of NES cells.

28. The method of claim 27, wherein the indication indicates at least one of: (1) whether the UL-WUS configuration for the NES cell is applicable to the remainder of the set of NES cells, (2) a list of frequencies where the UL-WUS configuration for the NES cell is applicable, (3) a list of cell identifiers and carrier frequencies where the UL-WUS configuration for the NES cell is applicable, (4) a delta configuration of the UL-WUS configuration for the NES cell associated with the remainder of the set of NES cells or an index of parameters associated with the remainder of the set of NES cells.

29. The method of claim 28, wherein whether the UL-WUS configuration for the NES cell is applicable to the remainder of the set of NES cells is represented by one bit.

30. The method of claim 28, wherein the indication indicates the list of frequencies where the UL-WUS configuration for the NES cell is applicable, the delta configuration of the UL-WUS configuration for the NES cell associated with the remainder of the set of NES cells, and the index of parameters associated with the remainder of the set of NES cells.
